(19) United States
(12) Patent Application Publication
(10) Pub. No.: US 2018/0281165 A1
(43) Pub. Date: Oct. 4, 2018

(54) REVERSIBLE WRENCH TOOL

(71) Applicant: Dallas Kempiak, Montgomery, IL (US)

(72) Inventor: Dallas Kempiak, Montgomery, IL (US)

(21) Appl. No.: 15/470,912

(22) Filed: Mar. 28, 2017

(51) Int. Cl. B25F 1/02; B25B 13/46; B25B 23/00; B25G 1/10; B25B 15/00

(52) U.S. Cl. CPC B25F 1/02; B25B 13/462; B25B 15/007; B25G 1/102; B25B 15/005; B25B 23/0035

(57) ABSTRACT

A reversible wrench tool that includes a ratchet housing, a handle and a reversible screwdriver bit. A dual ratchet socket is extended through the ratchet housing and clicked into place and a lever disposed on the ratchet housing underneath the dual ratchet socket, the lever is moved to release or secure the first end and the second end of the dual ratchet socket from the dual ratchet socket. The reversible wrench tool includes a screwdriver head that is a head selected from the group consisting of a Phillips screwdriver head, a flat screwdriver head, a T-25 screwdriver head or a T-27 screwdriver head. The reversible wrench tool is made with alloy steel with chromium and vanadium.

### BACKGROUND OF THE INVENTION

### 1. Field of the Invention

The present invention relates to a wrench. More specifically, the present invention relates to a reversible wrench tool that may be utilized to repair a chainsaw or other suitable equipment.

### 2. Description of the Related Art

Scrench tools are traditionally utilized to service chainsaws. The scrench tool is a combination of a wrench and a screw driver and is a specialty tool designed for the specific needs of a chainsaw. The scrench tool has a 19 mm and a 13 mm socket that is standard for working on a chainsaw.

The traditional scrench tool, although very useful has some limitations. Often times when working on a chainsaw, having a ratcheting capability would be extremely helpful, since the ratcheting capability has additional sizes in addition to the standard 19 mm and 13 mm socket sizes. Although the scrench tool is valuable, it does not have ratchet capabilities or housing.

What is needed is a reversible wrench tool to provide more ratchet sizes and screwdriver head sizes as well as a ratcheting capability to have a capability to work on more and different types of chainsaws than a scrench. The reversible wrench tool may also be utilized to repair other suitable equipment such as motorcycle parts and components.

### SUMMARY OF THE INVENTION

The present invention relates to a wrench. More specifically, the present invention relates to a reversible wrench tool that may be utilized to repair a chainsaw or other suitable equipment.

The reversible wrench tool includes a ratchet housing receiving a dual ratchet socket, a handle having a top portion and a bottom portion, the ratchet housing is disposed on the top portion of the handle and a reversible screwdriver bit removably inserted into a fitted aperture disposed on the bottom portion of the handle.

It is an object of the present invention to provide a reversible wrench tool that includes a ratchet housing with a 13 mm and a 19 mm socket on each end of the ratchet housing and a screwdriver.

It is an object of the present invention to provide a reversible wrench tool that includes a fitted aperture having a magnet contained within the fitted aperture to facilitate holding the reversible screwdriver bit within the fitted aperture.

It is an object of the present invention to provide a reversible wrench tool that includes a dual ratchet socket that is extended through the ratchet housing and clicked into place and a screwdriver head that is disposed on the first end of the elongated bit base.

It is an object of the present invention to provide a reversible wrench tool that includes a screwdriver head selected from the group consisting of a Phillips screwdriver head, a flat screwdriver head, a T-25 screwdriver head or a T-27 screwdriver head.

It is an object of the present invention to provide a reversible wrench tool that may be utilized to repair other suitable equipment such as motorcycle parts and components.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a first side perspective view of a reversible wrench tool, in accordance with one embodiment of the present invention.

FIG. 2 illustrates a second side perspective view of a reversible wrench tool, in accordance with one embodiment of the present invention.

FIG. 3 illustrates a first front perspective view of a reversible wrench tool, in accordance with one embodiment of the present invention.

FIG. 4 illustrates a second front perspective view of a reversible wrench tool, in accordance with one embodiment of the present invention.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

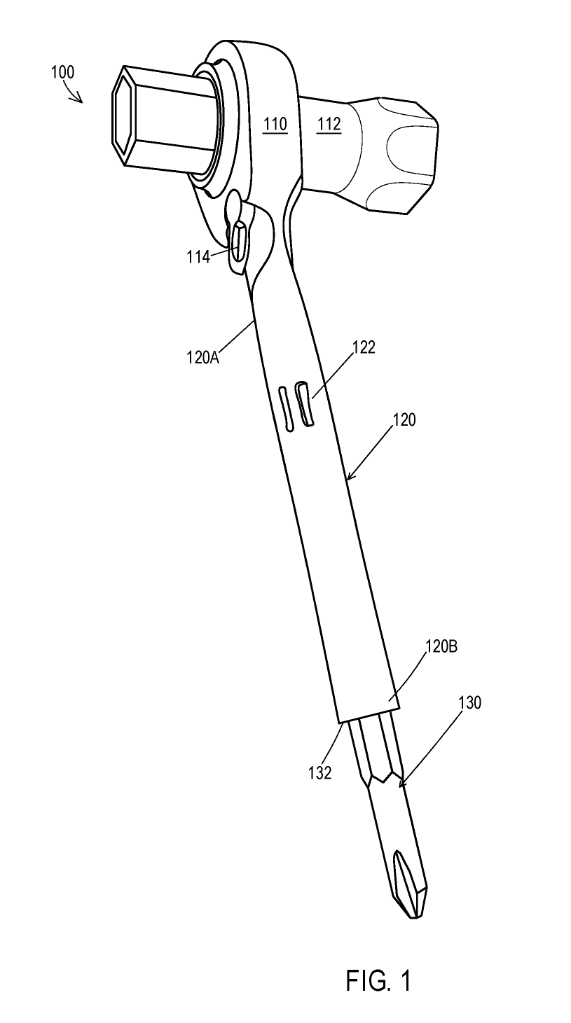

FIG. 1 illustrates a first side perspective view of a reversible wrench tool 100, in accordance with one embodiment of the present invention.

The reversible wrench tool 100 may include a ratchet housing 110, a handle 120 and a reversible screwdriver bit 130.

The ratchet housing 110 may receive a dual ratchet socket 112 that may be extended through the ratchet housing 110 and clicked into place. The dual ratchet socket 112 may also be welded to the ratchet housing 110. A lever 114 may be disposed on the ratchet housing 110 underneath the dual ratchet socket 112. The handle 120 may include a top portion 120A and a bottom portion 120B. The handle 120 may include a plurality of notches 122 to facilitate grasping the reversible wrench tool 100. The ratchet housing 110 may be disposed on the top portion 120A of the handle 120. The reversible screwdriver bit 130 may be removably inserted into a fitted aperture 132 disposed on the bottom portion 120B of the handle 120. The reversible wrench tool 100 may be utilized to repair other suitable equipment such as motorcycle parts and components (not shown).

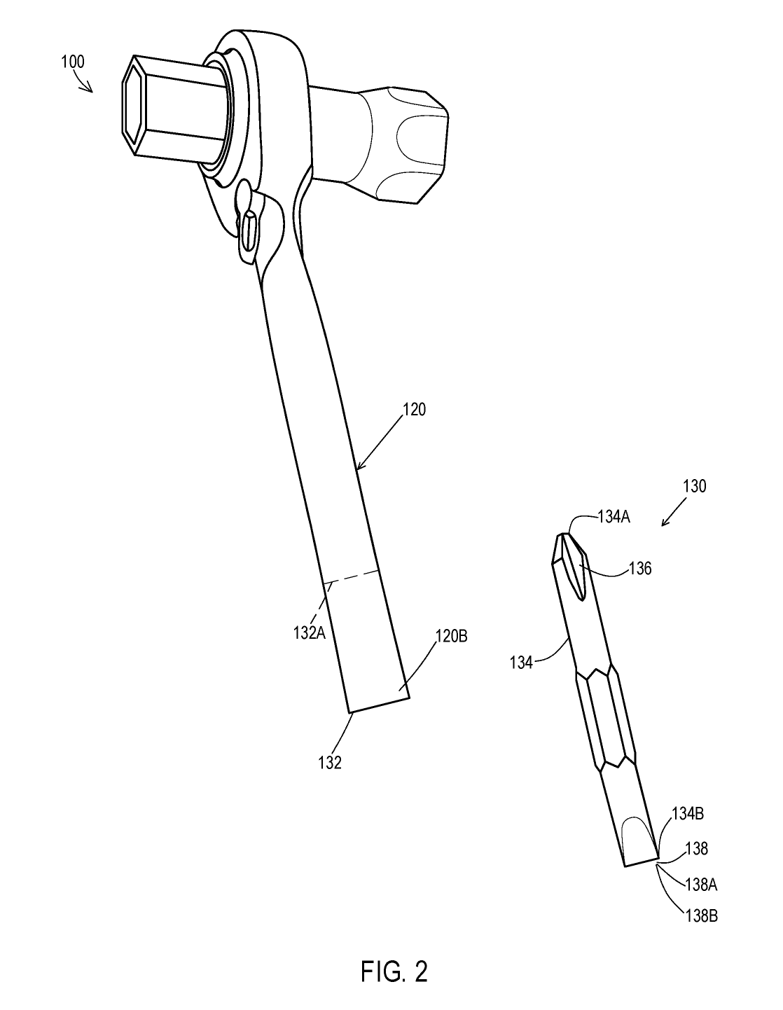

FIG. 2 illustrates a second side perspective view of a reversible wrench tool 100, in accordance with one embodiment of the present invention.

The reversible screwdriver bit 130 may include an elongated bit base 134 having a first end 134A and a second end 134B. The reversible screwdriver bit 130 may be approximately ¼ inch or the like. A Phillips screwdriver head 136 may be disposed on the first end 134A of the elongated bit base 134 and a flat screwdriver head 138, a T-25 screwdriver head 138A or a T-27 screwdriver head 138B may be disposed on the second end 134B of the elongated bit base 134. Either the Phillips head screwdriver 136 or the flat screwdriver head 138 may be first inserted into the fitted aperture 132 disposed on the bottom portion 120B of the handle 120 to contain the reversible screwdriver bit 130 while not in use. The fitted aperture 132 may be fitted to the dimensions of the reversible screwdriver bit 130. The fitted aperture 132 may also include a magnet 132A contained within the fitted aperture 132 to facilitate holding the reversible screwdriver bit 130 within the fitted aperture 132.

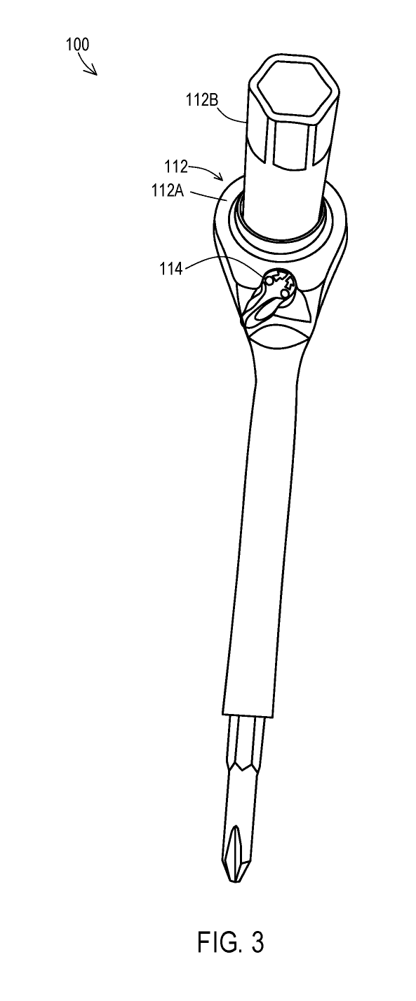

FIG. 3 illustrates a first front perspective view of a reversible wrench tool 100, in accordance with one embodiment of the present invention.

FIG. 3 illustrates the dual ratchet socket 112 with a first end 112A. The first end 112A of the dual ratchet socket 112 may be a 13 mm socket 112B or other suitable socket. The lever (FIG. 1, 114) may be moved to release or secure the 13 mm socket 112B from the dual ratchet socket 112. The first end 112A of the dual ratchet socket 112 may also accommodate a plurality of scrench sized sockets (not shown).

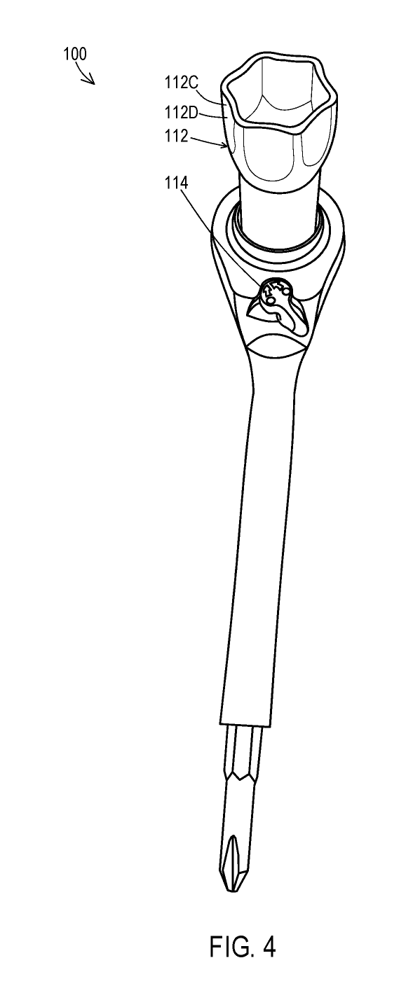

FIG. 4 illustrates a second front perspective view of a reversible wrench tool 100, in accordance with one embodiment of the present invention.

FIG. 4 illustrates the dual ratchet socket 112 with a second end 112C. The second end 112C of the dual ratchet socket 112 may be a 19 mm socket 112D or other suitable socket. The lever (FIG. 1, 114) may be moved to release or secure the 19 mm socket 112D from the dual ratchet socket 112.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A reversible wrench tool, comprising:
a ratchet housing receiving a dual ratchet socket;
a handle having a top portion and a bottom portion, the ratchet housing is disposed on the top portion of the handle; and
a reversible screwdriver bit removably inserted into a fitted aperture disposed on the bottom portion of the handle.

2. The reversible wrench tool according to claim 1, wherein the dual ratchet socket is extended through the ratchet housing and clicked into place.

3. The reversible wrench tool according to claim 1, wherein the dual ratchet socket is welded to the ratchet housing.

4. The reversible wrench tool according to claim 1, wherein the handle includes a plurality of notches to facilitate grasping the reversible wrench tool.

5. The reversible wrench tool according to claim 1, wherein the reversible screwdriver bit includes an elongated bit base having a first end and a second end.

6. The reversible wrench tool according to claim 1, wherein the reversible screwdriver bit is approximately ¼ inch.

7. The reversible wrench tool according to claim 1, wherein the reversible wrench tool is made alloy steel with chromium and vanadium.

8. A reversible wrench tool, comprising:
a ratchet housing receiving a dual ratchet socket, the dual ratchet socket includes a first end and a second end;
a handle having a top portion and a bottom portion, the ratchet housing is disposed on the top portion of the handle;
a reversible screwdriver bit removably inserted into a fitted aperture disposed on the bottom portion of the handle, wherein the reversible screwdriver bit includes an elongated bit base having a first end and a second end; and
a lever disposed on the ratchet housing underneath the dual ratchet socket, the lever is moved to release or secure the first end and the second end of the dual ratchet socket from the dual ratchet socket.

9. The reversible wrench tool according to claim 8, wherein the dual ratchet socket is extended through the ratchet housing and clicked into place.

10. The reversible wrench tool according to claim 8, wherein the dual ratchet socket is welded to the ratchet housing.

11. The reversible wrench tool according to claim 8, wherein the handle includes a plurality of notches to facilitate grasping the reversible wrench tool.

12. The reversible wrench tool according to claim 8, wherein a screwdriver head is disposed on the first end of the elongated bit base.

13. The reversible wrench tool according to claim 8, wherein the screwdriver head is a head selected from the group consisting of a Phillips screwdriver head, a flat screwdriver head, a T-25 screwdriver head or a T-27 screwdriver head.

14. The reversible wrench tool according to claim 8, wherein the fitted aperture include a magnet contained within the fitted aperture to facilitate holding the reversible screwdriver bit within the fitted aperture.

15. The reversible wrench tool according to claim 8, wherein the reversible screwdriver bit is approximately ¼ inch.

16. The reversible wrench tool according to claim 8, wherein the first end of the dual ratchet socket is a 13 mm socket.

17. The reversible wrench tool according to claim 16, wherein the lever is moved to release or secure the 13 mm socket from the dual ratchet socket.

18. The reversible wrench tool according to claim 16, wherein the second end of the dual ratchet socket is a 19 mm socket.

19. The reversible wrench tool according to claim 18, wherein the lever is moved to release or secure the 19 mm socket from the dual ratchet socket.

20. The reversible wrench tool according to claim 8, wherein the reversible wrench tool is made alloy steel with chromium and vanadium.
